(19) United States
(12) Patent Application Publication
(10) Pub. No.: US 2007/0198761 A1
(43) Pub. Date: Aug. 23, 2007

(54) Connection management mechanism

(76) Inventors: Vicky P. Duerk, Shrewsbury, MA (US); Pak-lung Seto, Shrewsbury, MA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/321,212

(22) Filed: Dec. 28, 2005

(51) Int. Cl. G06F 13/40

(52) U.S. Cl. 710/307

(57) ABSTRACT

A host device is disclosed. The host device includes a receive frame and primitive sequence processor, a transmitter and a connection manager to open and terminate a connection with a target device.

### FIELD OF THE INVENTION

The present invention relates to computer systems; more particularly, the present invention relates to computer system interaction with hard disk drives.

### BACKGROUND

Serial attached storage protocols, such as Fibre Channel, serial ATA (SATA) and serial attached Small Computer System Interface (SCSI) (SAS) are becoming more prevalent for connecting storage devices to a computer system. In computer systems implementing such serial storage devices, one storage device in the system may communicate with others. For example, a device requesting data (referred to as the initiator device) may receive data from a target device.

Typically, communications between the devices may occur after an identification sequence and the establishing of connections between the devices. Connection establishments, input/output (I/O) transfers and terminations are typically performed by firmware. However, I/O transfers may be accelerated by being performed in hardware. Thus, connection establishments and terminations are left to be performed in firmware, resulting in hardware and firmware having to be synchronized to be able to correctly manage the transfers in order to maintain performance.

In such a scenario, the firmware notifies the hardware that the firmware has something to transmit. Hardware subsequently informs the firmware that the hardware is ready to transmit data, and waits until the firmware sets up a connection to the destination address. The hardware will then perform the data transfer. After the data transfer has been completed, the hardware informs firmware and lets the firmware manage the connection termination.

The above-described method may be a significant improvement from the pure firmware approach. Nonetheless, there is still an overhead attributed for firmware to perform the connection management, and for the interactions between firmware and hardware.

Moreover, in a fully automated protocol engine where hardware handles both the task scheduling and transport layer functions, the firmware/driver has no knowledge when and which task is being executed by hardware at a given moment. In this scenario, connection management in firmware becomes exceptionally difficult.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates one embodiment of an Open Address Frame for SAS protocol;

FIG. 3 illustrates one embodiment of a host bus adapter; and

FIG. 4 illustrates one embodiment of a connection between two devices.

### DETAILED DESCRIPTION

A connection management mechanism is described. In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

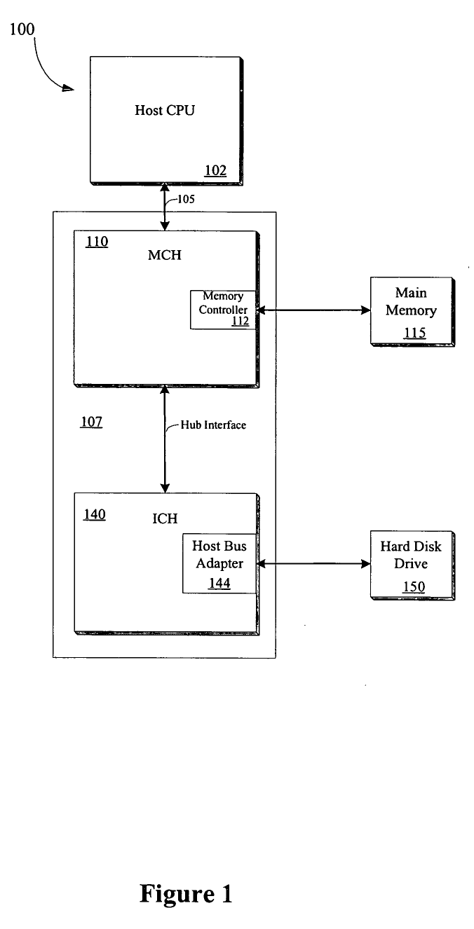

FIG. 1 is a block diagram of one embodiment of a computer system 100. Computer system 100 includes a central processing unit (CPU) 102 coupled to an interface 105. In one embodiment, CPU 102 is a processor in the Pentium® family of processors Pentium® IV processors available from Intel Corporation of Santa Clara, Calif. Alternatively, other CPUs may be used. For instance, CPU 102 may be implemented using multiple processing cores. In other embodiments, computer system 100 may include multiple CPUs 102

In a further embodiment, a chipset 107 is also coupled to interface 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to interface 105, such as multiple CPUs and/or multiple system memories.

MCH 110 is coupled to an input/output control hub (ICH) 140 via a hub interface. ICH 140 provides an interface to input/output (I/O) devices within computer system 100. ICH 140 may support standard I/O operations on I/O busses such as peripheral component interconnect (PCI), accelerated graphics port (AGP), universal serial bus (USB), low pin count (LPC) bus, or any other kind of I/O bus (not shown).

According to one embodiment, ICH 140 includes a host bus adapter (HBA) 144. HBA 144 serves as a controller implemented to control access to one or more storage devices 150. In one embodiment, storage device 150 is a serial attached SCSI (SAS) drive. However in other embodiments, storage device 150 may be implemented as other serial protocols.

As discussed above, communication may occur between devices upon establishing a connection if commanded by protocol between an end device such as HBA 144 (device A), and another end device such as storage device 150 (device B). Further, HBA 144 may be coupled to multiple storage devices via different ports. However in other embodiments, HBA 144 may be coupled to an expander device, which is coupled to other storage devices.

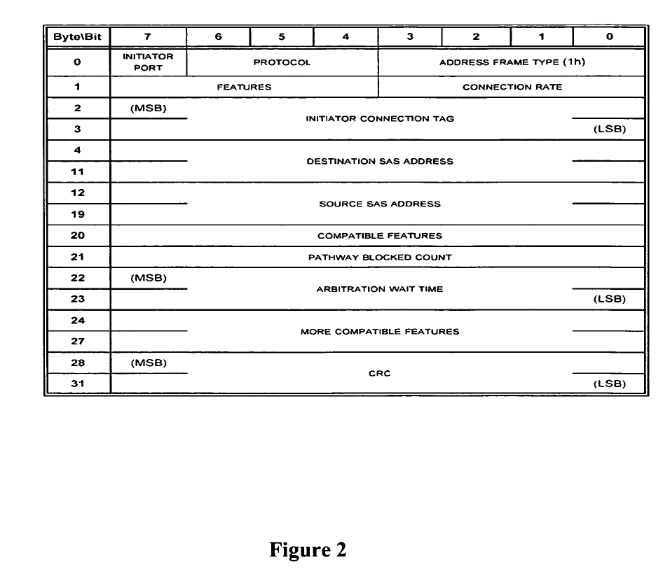

Typically, in SAS protocol, a source device makes a request to establish a connection by transmitting an open address frame to the destination device. The format of an open address frame is illustrated in FIG. 2. The open address frame includes an INITIATOR PORT bit, a CONNECTION RATE field and an INITIATOR CONNECTION TAG field. The INITIATOR PORT bit is set to one to specify that the source device port is acting as an initiator port. The INITIATOR PORT bit is set to zero to specify that the source port is acting as a target port.

The CONNECTION RATE field specifies the connection rate being requested between the source and destination. The INITIATOR CONNECTION TAG (ICT) field is used for Serial SCSI Protocol (SSP) and Serial ATA Tunneled Protocol (STP) connection requests to provide a SAS initiator port an alternative to using the SAS target port's SAS address for context lookup.

When a device (e.g., device A) is to communicate with another device (e.g., device B), device A builds an open address frame with its address as the source address and the address of device B as the destination SAS address. If device A is to open the connection to transmit command frames to device B, device A acts as an initiator. Therefore, device A sets the INITIATOR PORT bit to 1 in the open address frame. In this scenario, device A is the source, and device B is the destination. Device A is the initiator, and device B is the target.

In this scenario, device A opens a connection to device B. Device A retrieves a remote node context (RNC) that includes information related to the remote node, in this case device B. Typically, firmware may have previously assigned a remote node index (RNI) value to this remote node during topology discovery. Device A may use the RNI value to look up the RNC from the contents of a content addressable memory (CAM) that has been built by the firmware during discovery. This RNI value may be used by device A to fill in the ICT field in the open address frame.

Another scenario may occur where, assuming connection in the above scenario has been closed, and device B wants to send data frames to device A. In this case device B builds an open address frame with its SAS address as the source address and SAS address of device A as the destination SAS address. Since device B is trying to open a connection back to device A assuming the initial role of the last connection, device B sets the INITIATOR PORT bit to zero in the open address frame.

In this case, device B is the source, and device A is the destination. Device A is still the initiator, and device B is still the target. Further, device A receives an open address frame from device B with INITIATOR PORT bit set to zero and assumes the initiator role. Device A uses the ICT field as the RNI number to look up the RNC from the CAM to process the Open Address Frame.

According to one embodiment, HBA 144 includes hardware to perform connection establishments and terminations, in addition to I/O transfers. Although described with respect to an HBA, one of ordinary skill in the art will appreciate that the embodiment described below may be implemented in any type of end point device.

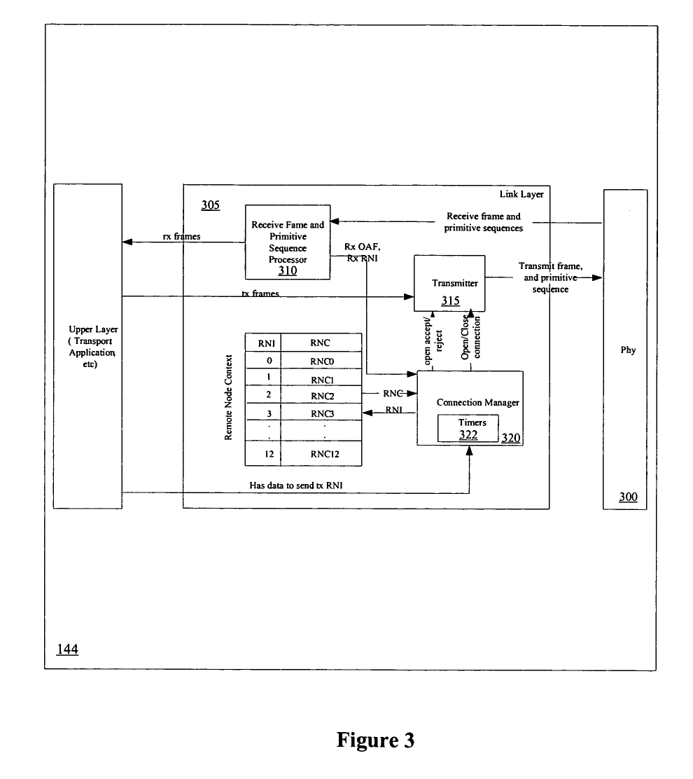

FIG. 3 illustrates one embodiment of a HBA 144. HBA includes a Phy 300 and a link layer 305. Phy 300 includes transmitter and receiver circuitry that communicates with other devices via cables and connectors. Further, Phy 300 performs encoding schemes and the phy reset sequence. Link layer 305 controls link level communication for each SAS link. Such communication includes an identification sequence, connection management, and frame transmission requested by the port layer (not shown), frame reception and primitive sequence processing/transmission.

Link layer 305 includes receive frame and primitive sequence processor 310, transmitter 315, connection manager 320. According to one embodiment, link layer 305 supports four physical links. Thus, link layer 305 includes four transmitters and four receivers in such an embodiment, although one of each is shown.

Receive frame and primitive sequence processor 310 detects an open address frame and parses out the information in the open address frame. Transmitter 315 is included to transmit frames and primitive sequences. The RNC look up table is a remote node context information table that is indexed by RNI.

Connection manager 320 controls the connection between device A and device B based upon the RNC contents received from the RNC lookup table. Connection manager 320 handles the establishing and terminating of a connection, as well as determining the lane for which a connection should be established if wide port is supported in protocol such as SAS.

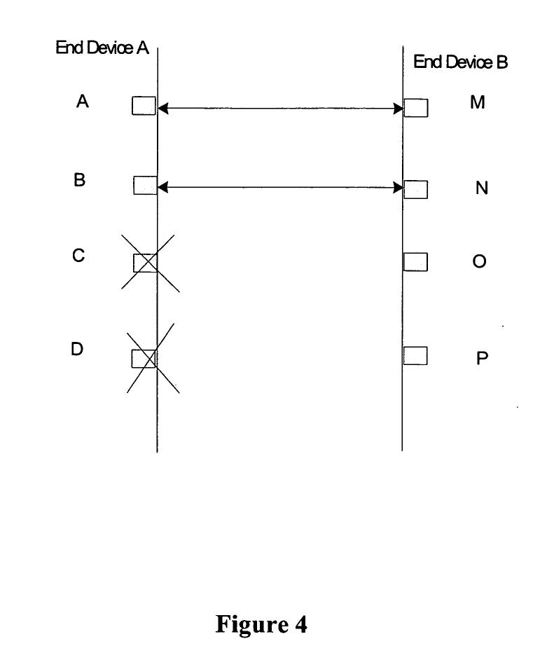

According to one embodiment, the four lanes of end device A are configured by firmware to be within one wide port. In such an embodiment, the firmware of end device A may establish the connection to end device B to two by taking the minimum port width of device A and B. FIG. 4 illustrates one embodiment of a connection between end device A and end device B.

Referring to FIG. 4, if there are already two connections open (A<->M, and B<->N), connection manager 320 may be responsible to verify the connection limit and current active connections, and recognize that the connection limit has already been reached. Therefore connection manager 320 does not try to open or accept a connection on the other two lanes C and D between end device A and end device B.

Referring back to FIG. 3, whenever a link is idle (e.g., neither device A nor B have any more frames to send), connection manager 320 may terminate the existing connection. In one embodiment, connection manager 320 includes link idle timers 322 to trigger the termination process. For instance, one timer monitors the transmit side, while another monitors the receive side. In other embodiments, the transmit timer and receive timer may also be shared.

The receive link idle timer may be stopped and reset at every start of frame detection, and started at every end of frame detection after connection has been established. The timer runs until either another start of frame is detected or the timer reaches its programmed maximum value. The transmit link idle timer may be stopped and reset at the beginning of transmission of each frame. The timer may start running at the completion of transmission of each frame until either another beginning of frame is transmitted or the timer reaches a programmed maximum value. When both timers reach the maximum value, which may be programmed separately, connection manager 320 terminates the connection since the link is likely to be idle.

In one embodiment, connection manager 320 may also be able to disable connection management for a particular link or port when the protocol does not require connection establishment. For example, the connection manager may be able to detect that the attached device is direct attached SATA or Point-to-point Fibre Channel interface. The detection may be accomplished during link initialization.

In SAS protocol, if a Maximum Burst Size field in a Disconnect-Reconnect mode page is not zero, a maximum amount of data that is transferred at one time by an SSP target port per I_T_L_Q nexus is limited by the value in the MAXIMUM BURST SIZE field. Connection manager 320 may handle the automatic closing of a connection when the data transferred reaches the size specified in this field. For example, if the maximum burst size is set to 16K bytes and a 64K byte 10 needs to be transferred, connection manager 320 may inform the transport layer to suspend the I/O and close the connection, or connection it may inform the transport layer to switch to another task with a different IO tag without closing the connection. On the receiver end, the link layer may also enforce its receiver logic to check the maximum burst size in order to detect any violations.

For STP connections, an affiliation may be established by an STP target port whenever an STP initiator port connects to the STP target port. After the connection is established, the STP initiator and the STP target devices can start sending and processing FIS's. When the host (e.g., HBA 144) wants to end this connection, the host sends a CLOSE primitive to the STP target port.

When an STP target port has an affiliation with an STP initiator, the STP target port must reject all new connection requests by other devices and can only accept connection to the STP initiator for which it has an affiliation. Thus, two versions of closing the connections are implemented. A Close (Normal) primitive will close an open connection only, while a Close (Clear Affiliation) will close an open STP connection and clear the affiliation.

If affiliations are not implemented by the STP target port, or the affiliation is not present, the Close (Clear Affiliation) primitive will be treated as Close (Normal). Connection manager 320 initiates the transmission of the CLOSE primitive to the STP target ports. If Native Command Queuing (NCQ) is implemented in the initiator and the outstanding active native command queue (NCQ) is not empty, connection manager 320 may keep the connection open until the outstanding active native command queue is empty. The NCQ status may be checked by reading a SActive register implemented in HBA 144. The SActive value represents a set of outstanding NCQ commands that have yet to be completed.

If all bits in SActive register are cleared, connection manager 320 may initiate closing of the connection. Unless instructed by a component external to link layer 305 (e.g., firmware or a task scheduler), the connection manager could send CLOSE (Normal) primitive to the target. Thus, the affiliation remains established in the target and the initiator has the exclusive access to the target. CLOSE (clear affiliation) is transmitted if connection manager 320 is instructed by the external component to inform the target to close connection and clear affiliation at the same time.

In another embodiment, connection manager 320 may also manage unfair arbitration in SAS. In such an embodiment, an Arbitration Wait Time (AWT) timer is used for arbitration fairness. The initial value of AWT timer may be set to 0. When connection manager 320 builds the open address frame to request a connection to a SAS target for the first time, it puts the AWT initial value in the corresponding field of the open address frame. The initial value of this timer may be programmed to any value between 0 and 7FFFH. In order to achieve unfair arbitration, the initial value of this timer is programmed to a non-zero value either by firmware or hardware. Connection manager 320 may also intelligently program the initial value of the AWT timer according to the type of I/O or remote node SAS address.

Whether it is the initiator or the target, if the connection rate is lower than the physical link rate, connection manager 320 is responsible to inform phy layer 300 to perform rate matching based on which remote node the connection is being established to. Further, if connection manager 320 detects that it is directly attached to a SSP or STP target port, then connection manager 320 may choose not to close the connection at all.

The above-described mechanism significantly reduces the overhead and completely removes the upper layer from connection management, thus improving performance.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A host device comprising:
A receive frame and primitive sequence processor;
a transmitter; and
a connection manager to open and terminate a connection with a target device.

2. The host device of claim 1 wherein the connection manager determines a lane for which a connection should be opened for a wide port protocol.

3. The host device of claim 1 wherein the connection manager terminates a connection with the target device upon detecting that the connection is idle.

4. The host device of claim 3 wherein the connection manager comprises one or more timers to monitor the connection.

5. The host device of claim 4 wherein the connection manager terminates the connection with the target device whenever the one or more timers reach a predetermined value.

6. The host device of claim 5 wherein the one or more timers are reset upon the host device receiving or transmitting a frame.

7. The host device of claim 1 wherein the connection manager automatically terminates a connection whenever a predetermined quantity of data has been transferred.

8. The host device of claim 1 wherein the connection manager terminates a STP connection by transmitting a CLOSE primitive to the target device.

9. The host device of claim 1 wherein the connection manager manages unfair arbitration.

10. A method comprising:
establishing a connection between a host device and a target device via a connection manager at the host device;
transferring input/output (I/O) data between the host device and the target device; and
terminating the connection if the connection manager detects that the connection is idle.

11. The method of claim 10 wherein terminating the connection further comprises:
determining whenever one or more timers have reached a predetermined value; and
terminating the connection if the one or more timers have reached the predetermined value.

12. The method of claim 11 further comprising resetting the one or more timers upon the host device receiving or transmitting data.

13. The method of claim 10 further comprising the connection manager terminating the connection whenever a predetermined quantity of data has been transferred.

14. The method of claim 10 further comprising:
the connection manager receiving a command from an external component to terminate the connection and clear affiliation with the target device; and
the connection manager transmitting a CLOSE (clear affiliation) to the target device.

15. The method of claim 14 further comprising the connection manager transmitting a CLOSE (Normal) primitive to the target device upon terminating the connection if no command is received from the external component.

16. A system comprising:
a target device; and
a host device, coupled to the target device, having:
a receive frame and primitive sequence processor;
a transmitter; and
a connection manager to open and terminate a connection with the target device.

17. The system of claim 16 wherein the connection manager terminates a connection with the target device upon detecting that the connection is idle.

18. The system of claim 17 wherein the connection manager comprises one or more timers to monitor the connection.

19. The system of claim 18 wherein the connection manager terminates the connection with the target device whenever the one or more timers reach a predetermined value.

20. The system of claim 16 wherein the connection manager automatically terminates a connection whenever a predetermined quantity of data has been transferred.

21. The system of claim 16 wherein the connection manager terminates a Serial ATA Tunneled Protocol (STP) connection by transmitting a CLOSE primitive to the target device.

22. The system of claim 16 wherein the connection manager manages unfair arbitration.

23. The system of claim 16 wherein the connection manager disables connection management for a link upon detecting that a protocol does not require connection establishment.
